(19) United States
(12) Patent Application Publication
(10) Pub. No.: US 2012/0188164 A1
(43) Pub. Date: Jul. 26, 2012

(54) GESTURE PROCESSING

(76) Inventors: Prasenjit Dey, Bangalore (IN); Sriganesh Madhvanath, Bangalore (IN); Ramadevi Vennelakanti, Bangalore (IN); Rahul Ajmera, Bangalore (IN)

(21) Appl. No.: 13/386,847

(22) PCT Filed: Oct. 16, 2009
(86) PCT No.: PCT/IN2009/000590

§ 371 Date: Jan. 24, 2012

(51) Int. Cl. G06F 3/033; G06F 3/02; G10L 15/00

(52) U.S. Cl. 345/163; 345/156; 704/E15.001

(57) ABSTRACT

Presented is method and system for processing a gesture performed by a user of a first input device. The method comprises detecting the gesture and detecting a user-provided parameter for disambiguating the gesture. A user command is then determined based on the detected gesture and the detected parameter.

### BACKGROUND

Computing systems accept a variety of inputs. Some computer applications accept gestures provided by input devices to enable easier control and navigation of the applications.

Gestures are ways to invoke an action, similar to clicking a toolbar button or typing a keyboard shortcut. Gestures may be performed with a pointing device (including but not limited to a mouse, stylus, and/or finger). A gesture typically has a shape associated with it. Such a shape may be as simple as a straight line or as complicated as a series of movements.

### BRIEF DESCRIPTION OF THE DRAWINGS

For a better understanding, embodiments will now be described, purely by way of example, with reference to the accompanying drawings, in which:

FIG. 1 shows a Personal Computer, PC, display according to an embodiment;

FIG. 2 shows the display of FIG. 1 being used in accordance with an embodiment;

FIG. 3 shows the display of FIG. 1 being used in accordance with another embodiment; and

FIG. 4 shows a handheld computing device according to an alternative embodiment.

### DETAILED DESCRIPTION

Embodiments provide a method of processing a gesture performed by a user of a first input device, wherein the method comprises: detecting the gesture; detecting a user-provided parameter for disambiguating the gesture; and determining a user command based on the detected gesture and the detected parameter. Accordingly, there is provided a natural and intuitive interface method by which to command an action using a gesture.

Embodiments comprise a computing device equipped with a microphone and a touch screen unit for visual image display to the user and manual input collection from the user. The touch screen display may be engaged by a finger or stylus, depending upon the type of components used, but for the sake of simplicity it refers primarily to finger interaction as discussed herein, without precluding the use of a stylus in certain embodiments.

Embodiments comprise an architecture and related computational infrastructure such that a parameter may be provided by a user so as to specify a gesture in more detail (in other words, disambiguate or qualify the gesture). Once specified, a gesture may be detected and combined with the parameter to determine a command or action desired by the user. Thus, embodiments may employ hardware and software such that a parameter may be identified and selected by the user, as well as hardware and software such that a gesture can be input and detected. A variety of architectures may be used to enable such functions.

The same hardware and software may be used to input both the gesture and the parameter. For example, a conventional mouse may be employed which enables a user to input a gesture using movement of the mouse and enables a parameter to be input using one or more buttons of the mouse, such as a special function button. Similarly, a touch screen display may be provided a second input device in addition to its touch sensitive portion, wherein the second input device enables a user to input a parameter for disambiguating a gesture provided using the touch sensitive portion.

One exemplary way of enabling a user to specify a parameter is to employ conventional voice recognition technology which is adapted to detect and determine a parameter which is spoken by the user. In such a system, a user provides an audible parameter (for example, by speaking).

Similarly, image recognition technology may be employed to detect and determine a parameter which is provided visually by the user. For example, a video camera may be arranged to detect a user's movement or facial expression.

The parameter may specify, for example, a target file location, target software program or desired command.

A natural and intuitive means of interaction is provided, enabling a user of such a system to feel as though he or she is physically interacting with the system, for example, by accurately propelling a selected data file in the direction of a target destination appliance. Thus, a unique and compelling-flick gesture interface is hereby disclosed as a means of selecting and sending a particular data file to a target destination.

A flick gesture, as described herein, is a simple gesture that includes a single movement of a pointing device. A flick gesture is easy for the user to remember and perform. Once a user has mastered a flick gesture, it can be applied in multiple directions to accomplish different tasks.

Operations may be associated with the flick gesture. These operations may include navigation forward, backward, scrolling up or down, changing applications, right click (which may or may not always be present in a stylus-based system), and arbitrary application commands. Further, a flick gesture does not need to have a predefined meaning but rather may be customizable by a developer or user to perform an action or combination of actions so that a user may have quick access to keyboard shortcuts or macros, for example.

The flick gesture may be consistent in its associated function across all applications in an operating system. Alternatively, a flick gesture may be contextual in the function associated with it (where the resulting operation tied to the flick gesture varies based on an application in which the flick gesture occurred).

Further, different input devices may modify actions associated with flick gestures. For instance, a first set of actions may be associated with flick gestures when performed by a stylus. A second set of actions may be associated with flick gestures when performed by another pointing device. The number of sets of actions may be varied by the number of different input devices.

The flick gesture may be direction independent or may be direction specific. If direction specific, the direction the flick is drawn in will determine the outcome.

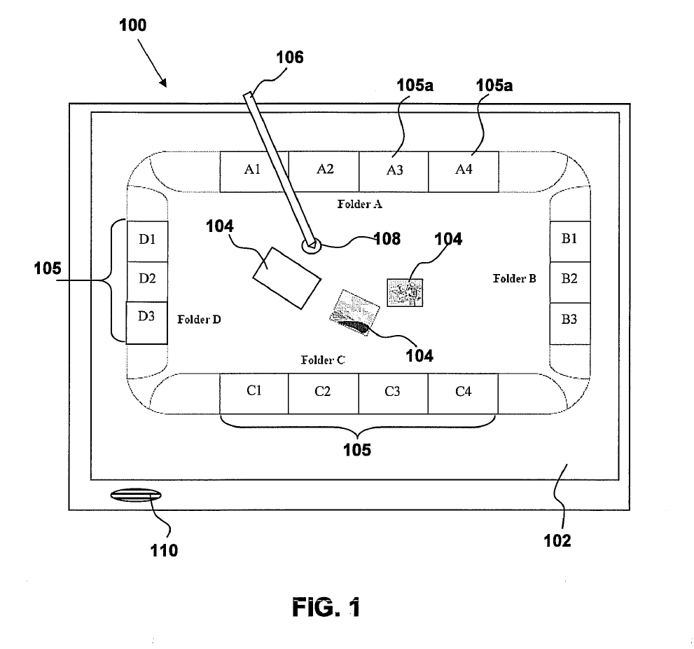

FIG. 1 illustrates a PC display 100 according to an embodiment. The PC display 100 includes a large display surface 102, e.g., a digitizing flat panel display, preferably, a liquid crystal display (LCD) screen, on which a plurality of electronic documents/files 104 and electronic document folders 105 is displayed. Each document folder 105 comprises a plurality of subfolders 105a. For example, folder “A” comprises first A1 to fourth A4 subfolders, and folder “B” comprises first B1 to third B3 subfolders.

Using stylus 106, a user can select, highlight, and/or write on the digitizing display surface 102. The PC display 100 interprets gestures made using stylus 106 in order to manipulate data, enter text, create drawings, and/or execute conventional computer application tasks such as spreadsheets, word processing programs, and the like.

Other types of input devices, such as a mouse, trackball, or the like could be used. Additionally, a user's own finger could be the stylus 106 and used for selecting or indicating portions of the displayed image on a touch-sensitive or proximity-sensitive display. Consequently, the term “user input device”, as used herein, is intended to have a broad definition and encompasses many variations on well-known input devices such as stylus 106. Region 108 shows a feedback region or contact region permitting the user to determine where the stylus 106 has contacted the display surface 102.

According to conventional embodiments, while moving objects on the screen, users have to drag the object and drop it to a target location. This requires the user to maintain attention through the entire time period of the interaction. Dragging the object across the screen can lead to inadvertent selection or de-selection of objects in the translation path, and it may be difficult to drag interface elements across the large screen. Further, use of a flick gesture for translation of objects across the screen to a target location imposes high cognitive load on the user to flick it in the correct direction, and with enough momentum in the flick to reach the desired target location.

The embodiment of FIG. 1, on the other hand, includes an architecture and related computational infrastructure such that a parameter may be provided by the user so as to specify a gesture in more detail. A gesture may therefore be combined with the specified parameter to determine a command or action desired by the user. Such a gesture which is combined with a parameter is hereinafter referred to as a multi-modal gesture because a single gesture may be used for multiple modes of operation, the chosen mode being dependent on the specified parameter. A parameter may specify, for example, a target file location, target software program or desired command.

Here, the PC display 100 comprises a microphone 110 for detecting user-specified parameters that are provided audibly. The microphone 110 is connected to a processor of the PC display 100 which implements an audio recognition process (such as voice recognition) to detect and determine audibly-provided parameters.

The PC display 100 enables a user to provide a gross or approximate flick gesture in an approximate direction and accompany this with a spoken or audible parameter specifying a target. As a result, the target location can be determined even when the accuracy of the direction and/or speed of the flick is reduced. Such a multi-modal flick enables a user to simply speak the name of the target destination and perform a flick gesture in the general direction of the target.

The multi-modal gesture concept specifies a general pattern of interaction where there is a gesture command part and there is parameter part of an interaction. For example, a multi modal gesture according to an embodiment may be represented as follows:

Multi-modal Gesture=Gesture Command+Parameter.

Thus, a multi-modal gesture as an interaction consists of two user actions that together specify a command. In one example, the two actions are a flick gesture and a spoken parameter. When the user speaks out the parameter together with the flick gesture, the spoken parameter is used as an extra parameter to specify the flick gesture in more detail, for example, by identifying a target destination in the flick direction. Such a multi modal flick gesture may therefore be represented as follows:

Multi-modal Flick Gesture=Flick Gesture+Spoken Parameter.

Considering now a multi-modal flick gesture in more detail, two categories of operation can be identified: (i) Object Translation; and (ii) Command Invocation.

Object Translation

The translation of media objects to target locations on a display such as that of FIG. 1 is a common task performed in direct manipulation interfaces. For example, sorting and organizing media objects into folders displayed on the display 100 of FIG. 1 requires selecting and translating the files 104 into a folder. A multi-modal flick gesture according to an embodiment allows for translation of files on a display screen using a flick gesture.

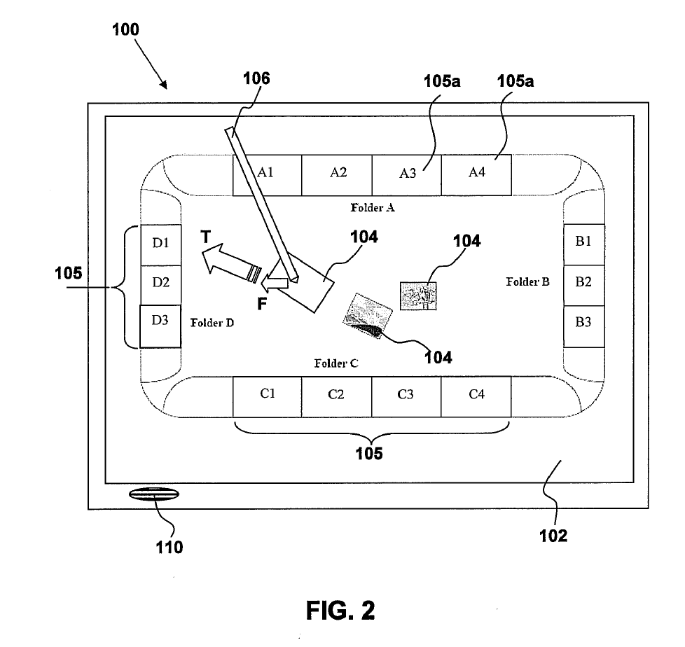

Referring to FIG. 2, a displayed document/file 104 can be translated to a target location on the display 102 by flicking it (i.e. by contacting the display 102 with the stylus 106 at the location of the file 104 and performing a flick gesture in the direction of the target location) and providing a parameter for the flick gesture using a speech command. The example of FIG. 2 illustrates a document file 104 selected with the stylus 106 being translated to a first sub-folder D1 of Folder D. Here, the user performs a flick gesture with the stylus in the general direction of Folder D by rapidly moving the stylus towards Folder D, as illustrated by the arrow labeled “F”. In conjunction with performing the flick gesture, the user specifies the target folder as being the first sub-folder D1 by speaking the target folder out loud (for example, by saying “one”). Detecting the audible parameter via its microphone 110, the PC display 100 combines the parameter “one” with the detected flick gesture and determines that the multi-modal gesture represents the user's desire to translate the file 104 to the first sub-folder D1 of folder D. The display 102 then displays the movement of the file 104 towards sub-folder D1 along the path illustrated by the arrow labeled “T”. It will therefore be appreciated that the file 104 is translated to the desired target destination despite the fact that the flick gesture performed by the user was not entirely accurate (i.e. was directed towards the second sub-folder D2 of folder D). Here, flicking with the name of the folder being pronounced in speech disambiguates the flick gesture by specifying the target destination.

Other parameters may be specified in addition to or instead of the target destination. For example, by saying “Copy to . . . (folder name) . . . ” or “Move to . . . (folder name) . . . ” a user can disambiguate a flick gesture by further specifying whether or not to leave a copy of the file on the display when translated to the destination folder.

It should be appreciated that the flick gesture in itself remains a complete gesture even without the additional parameter provided by the user. In other words, a flick gesture performed without an accompanying extra parameter will simply be processed as a conventional flick gesture.

Command Invocation

Multi-modal gestures according to an embodiment enables the specification of a parameter to accompany a gesture, thereby allowing navigation of multi-layered commands and control menus which would otherwise not be possible using conventional gesture recognition concepts.

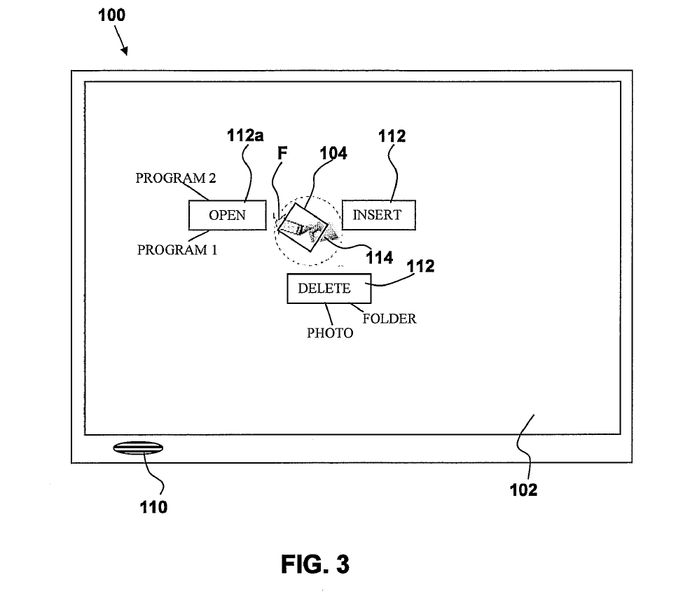

Referring to FIG. 3, a command menu can be navigated using a flick gesture (i.e. by contacting the display 102 with a finger at the location of the file 104 and performing a flick gesture in the direction of the target command menu) and providing a parameter for the flick gesture using a speech command. The example of FIG. 3 illustrates a first command menu 112 being invoked. Here, the user uses a finger 114 to perform a flick in the general direction of the first command menu 112 by touching the screen and rapidly moving the finger first command menu 112a in a flicking motion, as illustrated by the arrow labeled “F”. In conjunction with performing the flick gesture, the user specifies the target computer program with which the file should be opened by saying the program out loud (for example, by saying “Word”). Detecting the audible parameter via its microphone 110, the PC display 100 combines the parameter “Word” with the detected flick gesture and determines that the multi-modal gesture represents the user's desire to open file 104 using the computer program named “Word”.

It will therefore be appreciated that the file 104 is opened using the desired computer program despite the fact that the flick gesture performed by the user was ambiguous (i.e. was simply directed towards the command menu specifying the “open with” command”). Here, performing a flick gesture whilst the name of the computer program is pronounced in speech disambiguates the flick gesture by specifying the target computer program.

In this example, the direction of the flick gesture is used to select a first level of the menu and the speech parameter specifies a second level of the menu. Thus, the flick gesture direction specifies the command and the speech specifies a parameter.

Flick Gesture Determination

A flick gesture can be performed by a user simply by flicking their pen or finger against the screen. Flick gestures may be performed in the natural mode without necessarily requiring the user to enter any special modes—although a mode requirement may used in alternative embodiments, for example, requiring the user to hold a button while performing a flick gesture. The occurrence of a flick gesture may be determined based on a profile of the physical or logical x and y co-ordinates and the pressure (or location) charted against time.

A flick gesture may also be determined based upon timing information. Because a flick gesture of a human is a quick gesture, one or more predefined threshold is chosen to ensure the perceptual illusion that a user is in fact flicking the data file. A movement threshold may be, for example, greater than 1 cm and the time threshold greater than 0.2 milliseconds and less than 700 milliseconds. These values of course may be varied to accommodate all users. In some embodiments a threshold may be defined based upon the size of the screen and/or the distance of the graphical element from the pointing edge 109 of the screen. In one example embodiment where the screen is generally the size that fits in the palm of a user's hand, the predefined time threshold is 700 milliseconds. Here, a flick gesture is determined if a user's finger is tracked to target a graphical element associated with a data file and slid towards an edge 408 of the touch screen 402 in a time period that is greater than 0.2 milliseconds and less than 700 milliseconds.

In other embodiments, a velocity threshold may be used instead of or in addition to a speed threshold, wherein the velocity threshold defines a minimum velocity at which the user must slide his or her finger for it to qualify as a flick gesture.

Other aspects of a gesture may be compared against other thresholds. For instance, the system may calculate velocity, acceleration, curvature, lift, and the like and use these derived values or sets of values to determine if a user has performed a flick gesture.

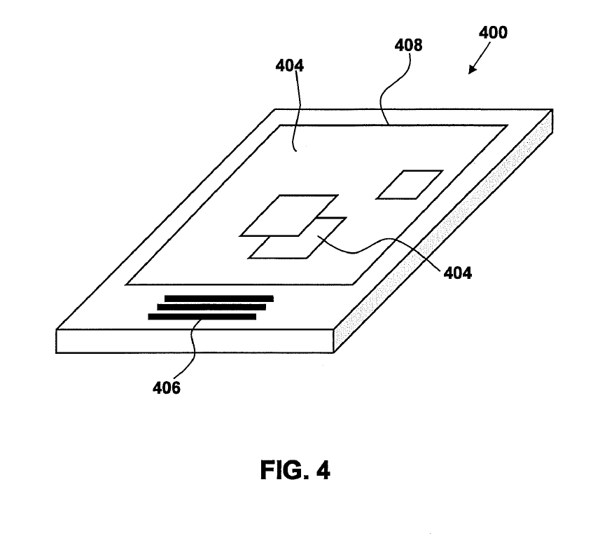

Referring now to FIG. 4, a handheld computing device 400 according to an embodiment includes a touch screen 402 which functions both as an output of visual content and an input for manual control. A conventional touch screen interface enables a user to provide input to a graphical user interface (“GUI”) 404 by manually touching the surface of the screen as a means of targeting and selecting displayed graphical elements. In general, simulated buttons, icons, sliders, and/or other displayed elements are engaged by a user by directly touching the screen area at the location of the displayed user interface element. For example, if a user wants to target and select a particular icon, button, hyperlink, menu element, or other displayed element upon the screen, the user touches the actual location upon the screen at which that desired element is displayed.

The handheld computing device 400 comprises a processing unit (not visible), a microphone 406 and data storage means (not visible). The data storage means stores one or more software programs for controlling the operation of the device 400.

The software program includes routines for enabling multi-modal gestures to be used wherein a physical gesture (such as a flick) imparted by the user upon the touch screen 402 can be disambiguated or further defined by a user-spoken parameter detected by the microphone 406. These routines may be implemented in hardware and/or software and may be implemented in a variety of ways. In general, the routines are configured to determine when a user provides an audible parameter for accompanying a gesture. The routines may determine this user provided parameter based upon at least one of: the detection of a gesture; the gesture being imparted upon a particular one of a plurality of data files; and the gesture being such that the user touches at least part of a graphical element that is relationally associated with a particular one of a plurality of data files.

The user may subsequently perform a flick gesture upon touch screen 101 by fingering a graphical element that is relationally associated with a desired data file and then flicking it, by dragging it quickly in a flick-like motion towards and off an edge 408 of touch screen 402. In response to this flick gesture upon the graphical element, the routines determine whether or not the user has provided a spoken parameter to be used in conjunction with the flick gesture. Here, for example, a different data storage drive may be associated with each edge of the screen and the user may then specify a target folder of the storage drive by saying the name of the target folder whilst performing a flick gesture in the general direction of the storage drive. In this way, the user may be made to feel perceptually as though he or she has physically flicked the data file into the target storage folder.

While specific embodiments have been described herein for purposes of illustration, various other modifications will be apparent to a person skilled in the art and may be made without departing from the scope of the concepts disclosed.

1. A method of processing a gesture performed by a user of a first input device, the method comprising:
detecting the gesture;
detecting a user-provided parameter for disambiguating the gesture; and
determining a user command based on the detected gesture and the detected parameter.

2. The method of claim 1, wherein the step of detecting the gesture comprises:
detecting movement of the input device;
comparing the detected movement with a predetermined threshold value; and
determining a gesture has occurred if the detected movement is equal to or exceeds the predetermined threshold value.

3. The method of claim 2, wherein the predetermined threshold value is at least one of: a value of speed; a velocity value; a duration of time; a measure of straightness; a coordinate direction; and acceleration value.

4. The method of claim 1, when the parameter is by provided using a second input device.

5. The method of claim 4, wherein the second input device is a microphone and wherein the step of detecting a user-provided parameter comprises detecting a sound input and processing the detected sound input in accordance with a speech-recognition process.

6. The method of claim 1, wherein the first input device comprises a mouse, a stylus or the user's finger.

7. The method of claim 1, wherein the gesture is a flick gesture.

8. A system for processing a gesture performed by a user of a first input device, the system comprising:
detection means adapted to detect the gesture and to detect a user-provided parameter for disambiguating the gesture; and
a processing unit adapted to determine a user command based on the detected gesture and the detected parameter.

9. The system of claim 8, wherein the detection means comprises:
movement detection means adapted to detect movement of the input device;
a comparison unit adapted to compare the detected movement with a predetermined threshold value; and
a gesture determination unit adapted to determine a gesture has occurred if the detected movement is equal to or exceeds the predetermined threshold value.

10. The system of claim 9, wherein the predetermined threshold value is at least one of: a value of speed; a velocity value; a duration of time; a measure of straightness; a coordinate direction; and acceleration value.

11. The system of claim 8, wherein the parameter is provided by using a second input device.

12. The system of claim 11, wherein the second input device is a microphone and wherein the detection means is to detect a sound input and process the detected sound input in accordance with a speech-recognition process.

13. The system of claim 8, wherein the gesture is a flick gesture.

14. A computer program comprising computer program code means to perform the steps of claim 1 when said program is run on a computer.

15. A non-transitory computer readable medium on which is stored machine readable instructions, said machine readable instructions, when executed by a processor, implementing a method of processing a gesture performed by a user of a first input device, said machine readable instructions comprising code to:
detect the gesture;
detect a user-provided parameter for disambiguating the gesture; and
determine a user command based on the detected gesture and the detected parameter.
